(19) United States
(12) Patent Application Publication
(10) Pub. No.: US 2019/0318323 A1
(43) Pub. Date: Oct. 17, 2019

(54) Cell Phone Battery Replacement/Refurbishment/Recycling Program and Method

(71) Applicant: Kyle Rose, SR., Huntsville, AL (US)

(72) Inventor: Kyle Rose, SR., Huntsville, AL (US)

(21) Appl. No.: 15/950,380

(22) Filed: Apr. 11, 2018

(51) Int. Cl. G06Q 10/00; G06Q 50/00; G06Q 50/26; G06Q 30/02

(52) U.S. Cl. CPC G06Q 10/30; G06Q 50/01; G06Q 30/0201; G06Q 30/0277; G06Q 50/26

(57) ABSTRACT

A rechargeable battery exchange program that comprises obtaining government, public, and or private Green Technology funding support. Furthermore employing the legislative process to assist in compliance implementation of federal, state and local battery collection, recycling, battery drop and waste management laws, ordinances and regulations. Coordinating with contractors to establish battery recycling centers implementing Green Technology disassembling and recycling procedures; contacting and contracting with waste management companies, service providers, and/or device manufacturers together with battery manufacturers for battery exchange program to exchange used batteries for new replacement batteries to power the device. Advertising and marketing, including social media rewarding customers with behavioral incentives in the form of but not limited to gift cards, discounts, store credits, and participating business tax credit incentive, the rechargeable battery exchange program locally and nationally with service providers and device sellers. Receiving a used battery and issuing a new replacement battery at the service provider or device seller store front at no cost to a consumer, and collecting used batteries from and delivering new replacement batteries to the service provider or device seller store front.

### CROSS-REFERENCE TO RELATED APPLICATION(S)

Not applicable.

### BACKGROUND OF THE INVENTION

### 1. Field of Invention

The present invention relates to the field of used battery disposal, more particularly to a program and method to replace a used cell phone battery with a replacement battery.

2. Description of Related Art

Cellular phones as well as numerous other mobile communication/computer devices (e.g. smart phones, tablet computers, laptops, and personal digital assistants (PDA)) have gained considerably popularity over the past decade. Many consumers carry one or more such devices with them at all times, and these devices are virtually the constant companion to teens throughout the US.

Such mobile devices depend on rechargeable batteries for their mobility. Most cell phones are powered by battery packs consisting of several individual battery cells electrically connected and contained in a polymer housing. The housing also includes plated metal electrical contacts on the surface for the battery cells. Metal wires or strips, such as copper or other electrical conductive metals, are used to connect the battery terminals.

The battery cells are typically based on lithium ion or nickel-cadmium metals, which lend themselves to repeated recharging and discharging cycles. These charging cycles can be repeated hundreds and even thousands of times and allow the battery to deliver adequate power to operate the cell phone. Despite the ability to be recharged repeatedly lithium and cadmium-based batteries can essentially “wear out.” This can be especially problematic in NiCad batteries, which need to he fully discharged and recharged to maintain peak efficiency (e.g. developing charge memory), and this rarely occurs with cell phones. While many times rechargeable batteries can often be refurbished by fairly simple manipulation of charging voltage and/or other electrical input to the battery, for most consumers the batteries are essentially permanently “bad” and need to be replaced. The typical consumer all too often throws the battery pack away in the home garbage, and these battery packs all too often end up in landfills, while the consumer goes on to buy a new battery pack. However, for the most part, the battery packs are either subject to easy refurbishment or the packs contain multiple good cell with only one bad cell causing a problem. If consumers could exchange their bad batteries for new (or refurbished) batteries, these used battery packs can be refurbished or recycled and not end up in a landfill

Prior methods for dealing with used batteries are mixed at best. Old bad, defective, non-charging cell phone batteries often end up tossed into public waste. Button batteries, especially, usually end up dumped in public and residential waste dispensers and ultimately landfills. Battery drop off boxes at cell phone and battery dealers attract some returns, but overall remain abysmally small considering their sale numbers for new batteries. City and municipal hazardous waste recycling authorities can accept most old batteries, but too often these waste are shredded and recycled without reutilizing intact components. Inexpensive online purchases of batteries for cost savings are prevalent, but generally lack any turn in option for old batteries.

Based on the foregoing, there is a need for a battery recycling program that accepts used, “bad” batteries in exchange for new batteries at no costs to the consumer. Such a program would promote successful recycling of component battery cells and lessen the numbers and amounts of toxic heavy metals entering landfills.

### SUMMARY OF THE INVENTION

A rechargeable battery exchange program that comprises obtaining government, public, and or private Green Technology funding support. Coordinating with contractors to establish battery recycling centers implementing Green Technology disassembling and recycling procedures; contacting and contracting with service providers and device manufacturers together with battery manufacturers for battery exchange program to exchange used batteries for new replacement batteries to power the device. Advertising and marketing the rechargeable battery exchange program locally and nationally with service providers and device sellers. Receiving a used battery and issuing a new replacement battery at the service provider or device seller store front at no cost to a consumer, and collecting used batteries from and delivering new replacement batteries to the service provider or device seller store front.

The device comprises a cell phone or a tool.

Commercializing and marketing the battery exchange program for economic profit to participating service providers and device sellers.

The Green Technology disassembling and recycling procedures comprises receiving used batteries at a recycling processor system; and analyzing used batteries at the recycling processor to classify as to refurbishment or disassembly/recycle/disposal.

The rechargeable battery exchange program further comprising sorting batteries for refurbishment according to a required refurbishing process, refurbishing batteries according to the required refurbishing process, certifying batteries for use, and delivering batteries to device manufacturers or service providers.

The rechargeable battery exchange program further comprising sorting batteries for disassembling/recycling/disposing; disassembling batteries into components and processing for recycling/disposing, and classifying components to recycle as whole sub-assemblies or reduce to raw material.

The rechargeable battery exchange program further comprises recycling whole sub-assemblies and delivering the component sub-assemblies to battery or device manufacturers or service providers.

The rechargeable battery exchange program further comprising reducing components to raw material and selling or delivering recyclable material to battery manufacturers; and disposing of non-recyclable raw materials.

The raw materials comprise metals and polymers.

Advantages:

1. Improved use of renewable battery manufacturing components.

2. Improved effective lifetime of cell phones.

3. Improved user confidence in availability of cell phones.

4. Improved savings versus unnecessary purchases of new phones.

5. Reduced hazards caused by improperly disposed battery waste.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a block diagram of the processes/procedures of a recycling program, according to an embodiment of the present invention;

FIG. 2 is a block diagram of the recycling processes/procedures, according to an embodiment of the present invention.

### DETAILED DESCRIPTION OF PREFERRED EMBODIMENTS

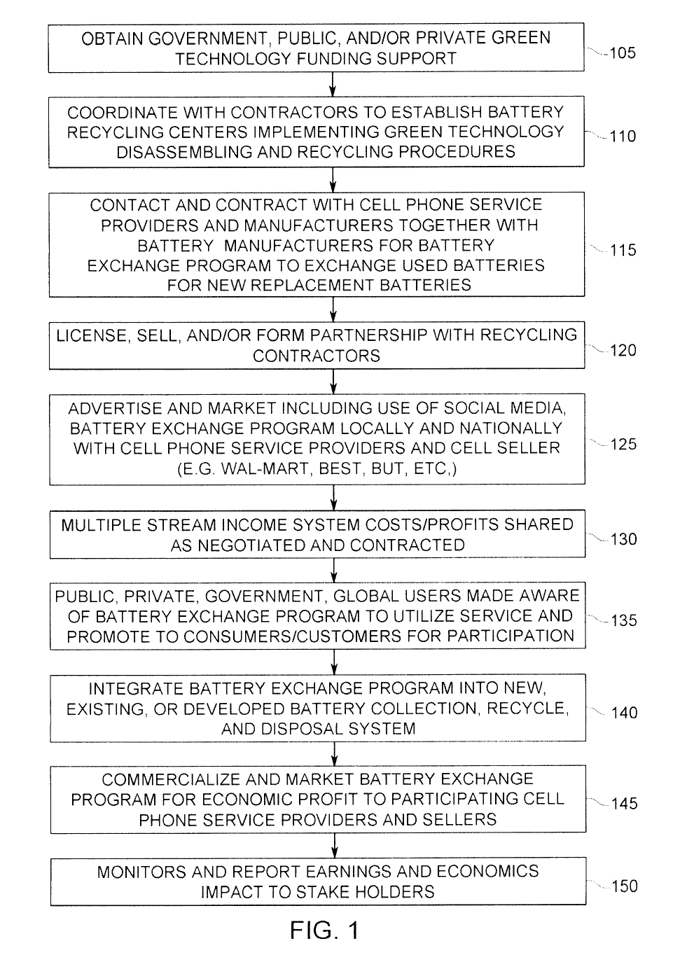

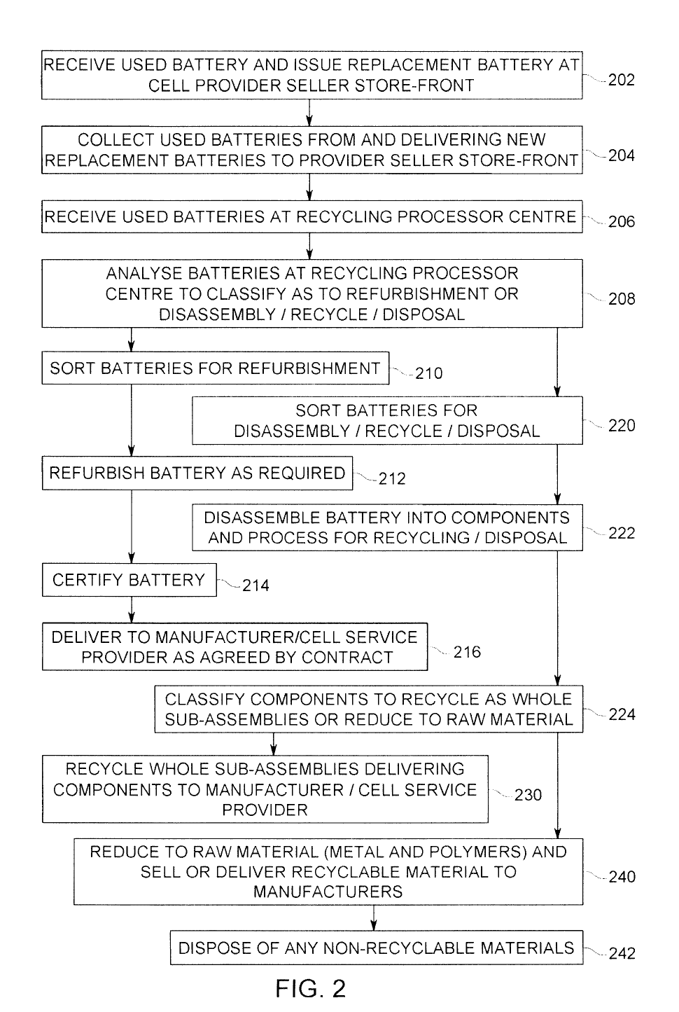

Preferred embodiments of the present invention and their advantages may be understood by referring to FIGS. 1-2, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. it must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcomhination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now he described in detail with reference to embodiments thereof as illustrated in the accompanying drawings.

FIG. 1 shows processes/procedures of a recycling program for rechargeable cell phone batteries. In step 105, program organizers/owners obtain government, public, and/or Green Technology funding support. These funds can enable initial funding based on avoiding the environmental harm represented by tons of hazardous heavy metals dumped into landfills and the economic savings offered by refurbishing used batteries for continued use or recycling material components rather than spending funds to manufacture new batteries from virgin materials. Furthermore, this can employ the legislative process to assist in compliance implementation of federal, state and local battery collection, recycling, battery drop and waste management laws, ordinances and regulations. In step 110, the organizers/owners coordinate with contractors to establish battery recycling centers implementing Green Technology disassembling and recycling procedures. This can include working with waste management companies and recyclers. These procedures can refurbish used batteries and/or disassemble and recycle components and sub-assemblies. In step 115, program organizers/owners contact and contract with cell phone service providers and manufacturers together with battery manufacturers for a battery exchange program to exchange used batters for new replacement batteries. These new batteries can be new in the sense that the batteries are issued to consumers fully certified to function according to operational specification even though the batteries themselves are refurbished or at least include some recycled components. In step 120, the program organizers/owners actually license, sell, and/or form partnerships with recycling contractors. This can include waste management companies. With this step accomplished, a viable Green Technology recycling program can be initiated.

In step 125, the various principals—program organizers/owners, cell phone service providers, manufacturers, and sellers—can advertise and market the battery exchange program locally and nationally with cell phone providers and cell phone sellers (e.g., Walmart, Best Buy, etc.). This can include using social media to promote the program. With implementation, in step 130, multiple stream income system costs/profits are shared as negotiated and contracted. These can also include distributing public and private grants and/or subsidies. In step 135, public, private, government, and other global users can be made aware of the battery exchange program to utilize the service and promote the program to consumers/customers for participation. In step 140, the various stakeholders can integrate the battery exchange program into new, existing, or developed battery collection, recycle, and disposal systems. This can further include waste management companies, municipal collection, and battery drop centers. In step 145, the various stakeholders can act to commercialize and market the battery exchange program for economic profit to participating cell phone service providers and sellers. It is currently contemplated that most consumers will approach their cell phone providers or sellers to exchange their phones, and further that in order to become economically sustainable, it is essential that providers and sellers see a clear economic benefit.

FIG. 2 shows a block diagram for the recycling process/procedures as called for in step 110 according to an embodiment of the current invention. In step 202, the cell provider or seller receives a used battery at a cell provider/seller store-front. In step 204, the program collects used batteries and deliver new replacement batteries to cell provider/seller store-front. In step 206, the recycling center receives used batteries at recycling processor center. In step 208, the recycler analyzes the batteries at the recycling processor center to classify as to refurbishment or disassembly/recycle/disposal. This can include running the battery through an analyzer to determine where there is a problem (dead cell, broken housing, damaged cells, inability to charge, needs higher voltage charging, needs controlled overcharging, etc).

Batteries at this point can then enter two processing paths: 1) refurbishment or 2) disassembly/recycle/disposal. The refurbishment path can proceed to step 210, where the processor sorts batteries for refurbishment. Sorting can include by battery type, and/or manufacturer. This can also involve organizing the selected batteries by manufacturer, model, and/or the type of refurbishment required. In step 212, the processor can refurbish the battery required, and in step 214 the processor can certify the battery. Certified batteries can be confirmed as performing according to specifications and can include a warranty set according to original manufacture data in conjunction with tested performance criteria. In step 216, the processor can deliver to manufacturers/cell service providers as agreed by contract the refurbished batteries.

The disassembly/recycle/disposal path can proceed to step 220, where the processor can sort batteries for disassembly/recycle/disposal. During this process, batteries are disassembled to recycle and dispose component parts. In step 222, the processor can disassemble a battery into components and process the components for recycling and/or disposal. In step 224, the processor can classify components to recycle as a whole sub-assemblies or reduce to raw material (e.g., copper, polymer, gold, silver, etc.) From step 224, the process can proceed to either step 230 or 240. In step 230, the processor can recycle whole sub-assemblies by delivering components to manufacturers and/or cell service providers. For example, in a given battery back, the only flaw in the battery can be a damaged housing, with the individual battery cells still good needing to only be incorporated into a new housing. The components can be sold back to manufacturers for cash or credit for the components by type and/or weight.

In step 240, the processor can reduce to raw materials (e.g., metals and polymers) and sell or deliver recyclable material to manufacturers. In this step, the various sub-assembles can essentially be shredded to sell back to manufacturers for cash or credit for raw, virgin, base materials and core elements by type and/or weight. In step 242, the processor can dispose of any non-recyclable materials.

### Novel, Innovative, and Advantageous

The program as described provides an earth friendly concept as pertains to cell phone battery disposal. The cell phone Service Provider industry customer base provides increased incentive to use the program to recycle batteries. The Battery Manufacturer Industry customer base provides increased incentive to use the program to recycle batteries. The program provides a solution to the enormous growth of the cell phone industry and attendant need to promote recycling versus disposal in a landfill and a solution to the enormous growth of the battery manufacturing recycling industry infrastructure.

The program can be implemented globally to rid hazardous waste and toxic materials by multitudes (billions of users). The disclosed marketing concept Impacts: workforce, commercialization, marketing, and Hazmat public awareness. The concept lends into the Green Technology for the global environment protection. The concept can drive competitive innovation for new battery storage. The program can further save monetary costs by a controlled battery collection and disposal process that includes swapping new batteries for old batteries. The public does not need to deal with tons of batteries in the public waste, damaging our global environment.

In alternative embodiments, the program can be extended to other rechargeable batteries, such as tool battery packs.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A rechargeable battery exchange program, comprising:
obtaining government, public, and or private Green Technology funding support;
coordinating with contractors including waste management companies to establish battery recycling centers implementing Green Technology disassembling and recycling procedures;
contacting and contracting with service providers and device manufacturers together with battery manufacturers for battery exchange program to exchange used batteries for new replacement batteries to power a device;
advertising and marketing, to include using social media, the rechargeable battery exchange program locally and nationally with service providers and device sellers;
receiving a used battery and issuing a new replacement battery at the service provider or device seller store front at no cost to a consumer; and
collecting used batteries from and delivering new replacement batteries to the service provider or device seller store front.

2. The rechargeable battery exchange program of claim 1, wherein the device comprises a cell phone or a tool.

3. The rechargeable battery exchange program of claim 1, further comprising
commercializing and marketing the battery exchange program for economic profit to participating service providers and device sellers.

4. The rechargeable battery exchange program of claim 1, wherein the Green Technology disassembling and recycling procedures comprises:
receiving used batteries at a recycling processor system; and
analyzing used batteries at the recycling processor to classify as to refurbishment or disassembly/recycle/disposal.

5. The rechargeable battery exchange program of claim 4, further comprising:
sorting batteries for refurbishment according to a required refurbishing process;
refurbishing batteries according to the required refurbishing process;
certifying batteries for use; and
delivering batteries to device manufacturers or service providers.

6. The rechargeable battery exchange program of claim 4, further comprising:
sorting batteries for disassembling/recycling/disposing;
disassembling batteries into components and processing for recycling/disposing; and
classifying components to recycle as whole sub-assemblies or reduce to virgin, base, raw material or core elements for sale or credit to battery manufacturers.

7. The rechargeable battery exchange program of claim 6, further comprises recycling whole sub-assemblies and delivering the component sub-assemblies to battery or device manufacturers, waste management companies, or service providers.

8. The rechargeable battery exchange program of claim 6, further comprising:
reducing components to raw material and selling or delivering recyclable material to battery manufacturers; and
disposing of non-recyclable raw materials.

9. The rechargeable battery exchange program of claim 7, wherein the raw materials comprise metals and polymers.
